(19) United States
(12) Patent Application Publication
(10) Pub. No.: US 2007/0083313 A1
(43) Pub. Date: Apr. 12, 2007

(54) Device and method for regulating the speed of a vehicle during maneuvering/parking of the vehicle

(76) Inventors: Werner Uhler, Bruchsal (DE); Dirk Schmid, Simmozheim (DE)

Correspondence Address: KENYON & KENYON LLP, ONE BROADWAY, NEW YORK, NY, 10004, US

(21) Appl. No.: 11/636,106

(22) Filed: Dec. 8, 2006

Related U.S. Application Data
(62) Division of application No. 10/945,669, filed on Sep. 20, 2004.

(30) Foreign Application Priority Data
Sep. 18, 2003 (DE) 103 43 174.8

(51) Int. Cl. G06G 7/76

(52) U.S. Cl. 701/70

(57) ABSTRACT

A device and method for regulating the speed of a vehicle during maneuvering/parking of the vehicle. The device may comprise a detection device for detecting objects within the surrounding area of the vehicle and for recording the distance to an object lying closest in the travel direction of the vehicle; a regulator for regulating the speed of the vehicle as a function of the position of an actuating device and of the distance to the most proximate object in the movement direction of the vehicle according to a predefined speed/distance relation; and a control device for automatically controlling a braking element and a driving device of the vehicle as a function of a corresponding output signal of the regulator.

### CROSS-REFERENCE TO RELATED APPLICATIONS

The present application is a division of U.S. patent application Ser. No. 10/945,669 filed on Sep. 20, 2004, which in turn claimed priority to German Patent Application No. 103 43 174.8 filed on Sep. 18, 2003.

### FIELD OF THE INVENTION

The present invention relates to a device and a method for regulating the speed of a vehicle during maneuvering/parking of the vehicle, in particular for motor vehicles such as passenger cars, during manual maneuvering/parking.

### BACKGROUND INFORMATION

Parking aids in the form of proximity warning devices having acoustic or optical warning systems are conventional and are utilized in today's passenger cars. Generally, these are systems which measure the distance to an object within a predefined detection range with the aid of ultrasonic sensors, which are located in the rear and/or front guard plate of the passenger car. Via an optical bar display or an audible signal, this parking pilot system indicates the distance to the object in the detection range in encoded form.

In addition, a driving force control apparatus for moving a vehicle by a desired small distance for parking the car is described in U.S. Pat. No. 6,006,144 to Takahashi et al., the vehicle being equipped with a throttle-valve actuator and the driving force control apparatus comprising: an input means for inputting a command to enter an automatic mode of the vehicle from a non-automatic driver-operated mode so as to move the vehicle the small desired distance, wherein the move command provides for entering of the automatic mode when the move command is input after the vehicle has reached a full stop in the non-automatic mode; a throttle-valve control means for inputting a throttle-valve opening angle to the throttle-valve actuator; a detection device for detecting an instantaneously moved distance of the vehicle; an obstacle-detection means for detecting a distance between the vehicle and an obstacle occurring near the vehicle; a comparing means for comparing the detection signal of the obstacle-detection means and the small desired distance; a move distance changing means for lessening the small desired distance by a predefined amount when the comparing means decides that the obstacle is within the small desired distance; and a braking-force generating means for stopping the vehicle when the actual moved distance becomes equal to the small desired distance for a first case where no obstacle is determined to be located within the small desired range, and for stopping the vehicle when the actual moved distance becomes equal to the small desired distance lessened by the preset amount for a second case where an obstacle is determined to be within the small desired distance. This patent thus describes a system which allows an automated approaching of an object during parking, the driver being largely unable to influence the process.

### SUMMARY

A device and method according to an example embodiment of the present invention for regulating the speed of a vehicle during maneuvering/parking of the vehicle/speed of the vehicle may offer the advantage that the deceleration procedure when pulling into or out of a parking space or during maneuvering is controlled by a speed regulator as soon as an object is identified within the detection range of a detection device. Reference variables are both the driving-pedal position and also the instantaneously measured distance to the closest object or obstacle in the travel direction of the vehicle. In an advantageous manner the vehicle is stopped automatically, safely and comfortably, i.e., gently, at a predefined small safety distance from detected objects.

Moreover, the driver retains control over the vehicle at all times, i.e., he is able to largely select the vehicle speed at will, to adjust it with great precision and to stop the vehicle instantaneously at any time. In addition, notwithstanding the automatic function, the driver is advantageously given the feeling of being in charge of the driving maneuver without becoming a slave to the system and having no intervention possibility. Furthermore, only the driver will be responsible for the safety in maneuvering. One feature in this context is that the vehicle moves only when the driver activates the accelerator. If he takes his foot off the accelerator or if no change is made in the zero setting of a corresponding activation means, the vehicle remains stationary. Finally, the presence of detected objects is clearly indicated to the driver in an advantageous manner independently of any available displays (acoustical or optical) of the parking aid.

In accordance with the present invention, the driving speed when pulling into or out of a parking space and during maneuvering automatically adapts to an obstacle situation and the driver input. The driver is able to activate the function as required and utilize it in a defined speed range between 0 and 10 km/h, for example, in each driving direction. The purpose of this parking brake function, also known as “park-stop”, is to reduce the work load on the driver by a largely automatic speed control, and thus a distance control, and safe braking of the vehicle in front of detected objects. A purely indicating warning system is thus expanded to an intervening comfort system.

In other words, a device is provided for regulating the speed of a vehicle during maneuvering/parking of the vehicle, which comprises: a detection arrangement for detecting objects within the surrounding area of the vehicle and for recording the distance to an object lying closest to the vehicle in the travel direction of the vehicle; a regulating device for regulating the speed of the vehicle as a function of the setting of an activation means and of the distance to the object lying closest in the travel direction of the vehicle according to a predefined speed/distance relation; and a control device for automatically controlling a braking device and a driving force apparatus of the vehicle as a function of a corresponding output signal of the regulating device.

According to a preferred further development, the detection device may include ultrasound sensors and/or radar sensors and/or lidar sensors, which are preferably provided at the vehicle front and/or the vehicle rear. This has the advantage of surroundings detection with the aid of conventional sensors in the front and rear region of the vehicle.

According to another preferred further development, an energizing device for activating/deactivating the regulating device is provided, which is able to be activated manually and/or semi-automatically when manually shifting into a reverse-driving stage of the driving apparatus. The parking brake function is thus able to be activated and deactivated in an uncomplicated manner.

According to another preferred further development, the actuation arrangement include a driving pedal or an accelerator, each preferably having an arrangement for detecting the positional angle. This has the advantage of making it possible to use the accelerator, which is provided in the vehicle anyway, to simultaneously perform the speed setpoint selection during maneuvering.

According to an additional preferred further development, a display arrangement is provided for the visual and/or acoustic display of the distance to the most proximate object in the travel direction of the vehicle. Thus, in addition to the noticeable braking of the vehicle, the driver is informed of the distance in encoded form when approaching an obstacle or object.

According to another preferred further development, a change in the position—preferably the angle—of the actuating device changes the setpoint speed of the vehicle during maneuvering, preferably in the range between 0 and 10 km/h, following activation of the regulating device, up to a second predefined distance to the closest object in the travel direction, the second predefined distance being greater than or equal to the first predefined distance. This has the advantage of a simple setpoint speed selection when the parking- or maneuvering-brake function is activated.

According to an additional preferred further development, a change in the position—preferably the angle—of the actuating device, away from a zero setting, after activation of the regulating device and after attainment of a second predefined distance reduces the distance between the vehicle and the most proximate object in the travel direction up to the first predefined distance while automatically stopping the vehicle, the actual distance between the first and second predefined distance thereupon preferably being a function of the setting of the actuating device. In this manner, it is possible to advantageously adapt the distance to the nearest-lying obstacle in the travel direction.

According to an additional preferred further development, the vehicle stops after activation of the regulating device at a zero setting of the actuating device, a manual braking intervention being allowed at all times via a brake pedal, and incline and slope preferably being compensated in their effect on the vehicle. As a result, to control the driving speed during a parking maneuver, the driver advantageously operates only the driving pedal, i.e., accelerator, the operation of the brake pedal not being necessary, yet possible at all times. The speed controller intervenes both in the engine management and in the brake control and compensates the influence of inclines and slopes. Nevertheless, the driver is able to activate the brake pedal at any time and thereby stop the vehicle immediately in the case of an emergency situation.

According to another preferred further development, the regulating device, once it has been activated, utilizes stored characteristics fields to generate the instantaneous setpoint speed as a function of the position of the actuating device and the distance to the most proximate object in the travel direction. In this manner a setpoint speed and thus a deceleration is indirectly provided when approaching an object or an obstacle.

### BRIEF DESCRIPTION OF THE DRAWINGS

Exemplary embodiments of the present invention are shown in the drawings and explained in greater detail in the description below.

FIG. 1 shows a schematic plan view of a passenger car having a speed controller, so as to elucidate an example embodiment of the present invention.

FIG. 2 shows a schematic diagram of a variant of a characteristics field, so as to elucidate an example embodiment of the present invention.

FIG. 3 shows a schematic diagram of another variant of a characteristics field, so as to elucidate an example embodiment of the present invention.

FIG. 4 shows a schematic diagram of another variant of a characteristics field, so as to elucidate an example embodiment of the present invention.

FIG. 5 shows a schematic block diagram, so as to elucidate an example embodiment of the present invention.

FIG. 6 shows a schematic block diagram, so as to elucidate an additional example embodiment of the present invention.

FIG. 7 shows a schematic block diagram, so as to elucidate an additional example embodiment of the present invention.

FIG. 8 shows a schematic state diagram, so as to elucidate the functioning method of an example embodiment of the present invention.

### DETAILED DESCRIPTION OF EXAMPLE EMBODIMENTS

Matching reference numerals in the figures denote identical or functionally equivalent component parts.

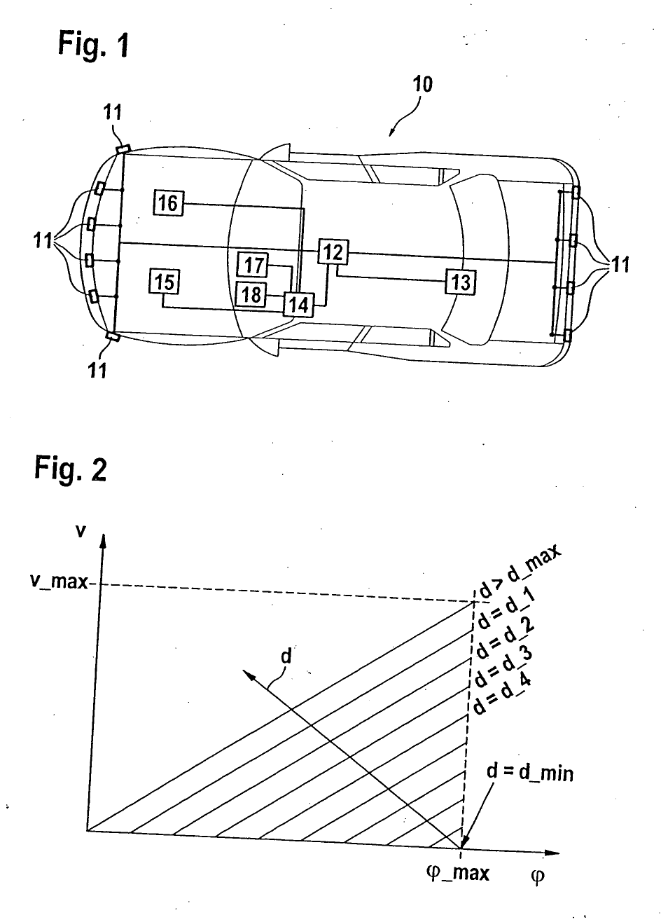

FIG. 1 shows the schematic plan view of a motor vehicle 10. In the rear and preferably also in the front, vehicle 10 has been provided with distance sensors 11 to detect objects or obstacles in the surrounding area of vehicle 10. Distance sensors 11 include, for instance, ultrasound sensors, radar sensors and/or lidar sensors and form a detection device. The signals from distance sensors 11 are conveyed to a processing means 12 in which distance d to a most proximate object, in particular in the travel direction of the vehicle, is determined. This distance d is preferably displayed in encoded form, visually and/or acoustically, i.e., by a bar display or a sound sequence, for example, by means of a display device 13, which is coupled to processing means 12. Distance d to the nearest object, preferably in the travel direction of vehicle 10, which is obtained in processing means 12 with the aid of distance sensors 11, is supplied to a regulator 14. Regulator 14 is coupled to a braking element 15 and a driving device 16 of the vehicle. Driving device 16 preferably includes a combustion engine transmission unit, the transmission or the power transmission (not shown) preferably allowing a variable torque transmission between combustion engine (also not shown) and the drive axle(s). An electric motor as driving device 16 is also possible.

Via energizing means 17, regulator 14 to which it is coupled, is able to be activated manually and/or semi-automatically, for instance when engaging a reverse driving gear step of vehicle 10. Regulator 14 may be deactivated via energizing means 17, preferably also manually. Regulator 14 is coupled to an actuating device 18, preferably to the driving pedal or accelerator of vehicle 10, which preferably includes a potentiometer to identify an angle v based on the neutral position of actuating device 18. Speed regulator 14 may preferably be integrated in processing means 12. As an alternative, a localization in control units of braking element 15 or driving device 16, for instance engine/transmission management, or some other control unit is possible. In addition to the position of actuating device 18, regulator 14 preferably also records the setting of the brake pedal, since a driver-initiated manual braking intervention is to be ensured at all times. Regulator 14 also analyzes signals, preferably from wheel pulse generators (not shown) so as to ascertain the speed and the travel distance of vehicle 10.

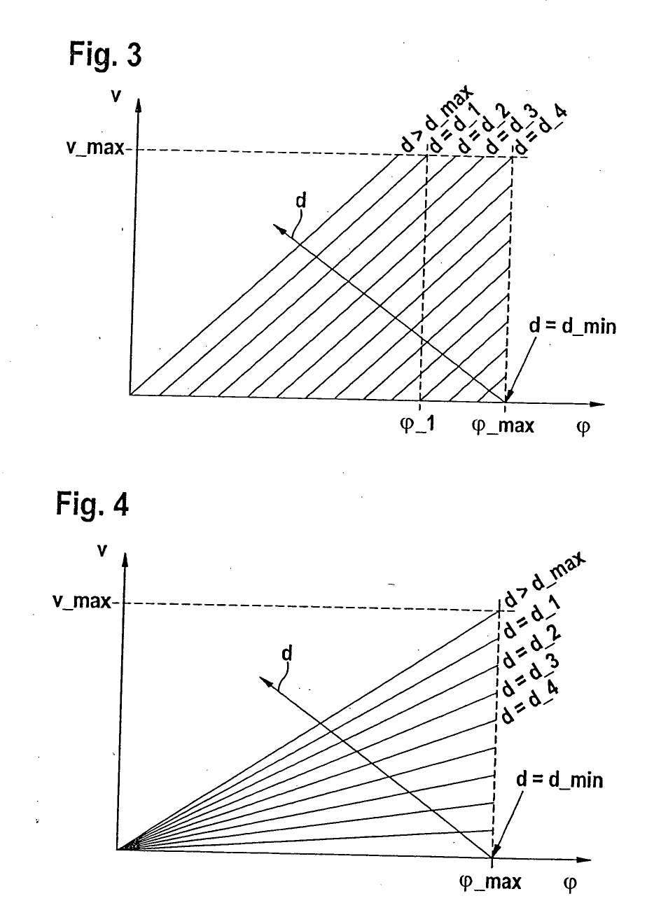

In the following, a few exemplary realizations are elucidated with respect to the basic functioning method of the system. Following activation of regulator 14 via energizing means 17, the release of the actuating device, preferably the driving pedal, i.e., neutral position ν=0°, means a setpoint speed of 0 km/h. A complete depression—i.e., angle ν=ν_max—means a setpoint speed v=v_max of preferably 10 km/h when no object or obstacle is identified in the detection range of detection device 11. Parameter v_max is adjusted in advance as a function of the desired characteristic of the braking deceleration and the capability of the surroundings-detection system, such as reach, latency period, detection reliability, etc. The simultaneous dependence of setpoint speed v on driving pedal position ν and distance d to an obstacle or object. occurring in the detection range is able to be represented as characteristics field according to FIGS. 2, 3 and 4. Various configurations of a characteristics field are possible, these resulting in a different control response of the system. In addition to the three configuration examples shown in the following paragraph, other configuration variants as desired are possible, which are able to be generated via a deviation of the characteristics line form from a straight line, for instance, or by a combination of the characteristics fields according to FIGS. 2 through 4 described in the following. In the examples according to FIG. 2 and FIG. 3, for instance, the gradient of the straight line may be varied.

The characteristics fields describe only the static dependence of setpoint speed v on the input variables, i.e., the angle ν of the actuating device with respect to the neutral position and distance d to a detected closest-lying object. The dynamic transient response, especially acceleration and deceleration processes in abrupt transitions between points situated at a considerable distance from each other in the characteristics field, which are relevant from the standpoint of comfort, safety and stability of the overall system, are not analyzed further in the following.

The characteristics field examples shown with reference to FIGS. 2, 3 and 4 share the following properties: If no obstacle or object is located in the detection range in the area surrounding vehicle 10, setpoint speed v may be increased continuously from zero up to v_max by changing the position of actuating device 18 away from the neutral position, for example by pressure on the driving pedal. By modifying the position of actuating device 18 in the direction of the neutral position, for instance by releasing the driving pedal, setpoint speed v may be reduced again in a corresponding manner. The obstacle-free case is characterized by the absence of detectable objects within the detection range of the sensory system, which has a maximum reach d=d_max. When approaching the closest-lying obstacle in the travel direction of the vehicle, regulator 14, in conjunction with driving device 16 and braking element 15, continually controls speed v downward up to 0 km/h. Vehicle 10 stops at a predefined distance d_min, i.e., at a safe distance from the obstacle or object. The overall control system prevents a collision in all positions of actuating device 18.

By varying the position of actuating device 18, such as driving pedal angle ν, the driver is able to influence the approach procedure toward the most proximate object in the travel direction of vehicle 10. A change in the position of actuating device 18 in the direction of the neutral position, i.e., a release of the driving pedal, once the vehicle has come to a standstill via regulator 14, for example, will not cause vehicle 10 to move away from the obstacle and thus no direction reversal. The vehicle remains at a stop in such a case.

By way of example and with reference to FIG. 2, a characteristic is shown in which maximum speed v_max is attained at maximum driving pedal angle ν_max following activation of regulator 14. Via the driving pedal position, the driver is able to continually control both setpoint speed v and the stopping distance, i.e., distance d to the most proximate obstacle in the travel direction of the vehicle at which vehicle 10 comes to a standstill. After vehicle 10 has come to a stop at a predefined distance d_1-d_4 to the closest-lying obstacle, it may be set in motion again by stronger pressure on the driving pedal, i.e., a larger angle relative to the neutral position, so as to approach the nearest object more closely. However, in doing so it is not possible to fall below an additional predefined distance d_min to the most proximate object.

The exemplary characteristics field according to FIG. 3 differs from the characteristics field elucidated with reference to FIG. 2 in that maximum speed v max is achieved already at a certain driving pedal angle ν_1, which is between ν=0 and ν=ν_max. If no obstacles are located in the surrounding area in the travel direction of vehicle 10, increased pressure on the driving pedal will not cause any further increase in setpoint speed v. On the other hand, when approaching an obstacle or the most proximate object in the travel direction of vehicle 10 and dropping below distance d_4, a change in driving-pedal angle ν in the range between ν_1 and ν_max will cause a continuous change in the driving speed. Via the driving pedal position, the driver is able to continually control both setpoint speed v and the stopping distance, i.e., distance d to the closest-lying obstacle in the travel direction of vehicle 10 at which the vehicle comes to a stop. Once the vehicle has come to a standstill at a predefined distance d_1-d_4, it can be set in motion again by greater pressure on the driving pedal so as drive up closer to the obstacle, a predefined minimum distance d_min being maintained between vehicle 10 and the most proximate object in the travel direction.

As an additional example, FIG. 4 shows a characteristics field via which maximum setpoint speed v_max is attained at maximum driving pedal angle ν_max. In this variant the stopping distance, i.e., distance d to the closest-lying object in the travel direction of vehicle 10 at which the vehicle comes to a stop, is unable to be continually controlled by means of the driving pedal position. Regardless of the driving pedal position, the vehicle basically comes to a stop at the selected safety distance d_min to the most proximate object in the travel direction of vehicle 10. However, by modifying the driving pedal position, the driver is able to influence the speed or acceleration profile until predefined safety distance d_min is reached. Nevertheless, prior to attaining predefined minimum distance d_min, the driver may interrupt the approach procedure during which speed v is generally automatically reduced by taking the foot completely off the driving pedal, i.e., neutral position of the driving pedal, thereby causing the vehicle to stop immediately.

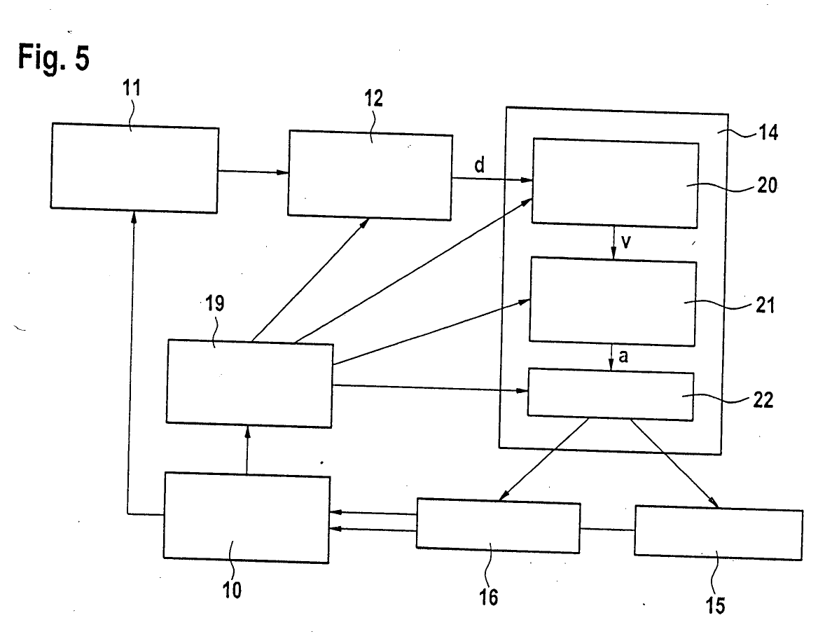

FIG. 5 shows a schematic block diagram in which detection device 11 or the surroundings sensory system of vehicle 10 forwards preferably a distance list to processing means 12 for situation evaluation. The distance list records the distances of the vehicle to objects in the surrounding area. The processing means identifies therefrom the most proximate object or obstacle in the travel direction of the vehicle and conveys its distance d to regulator 14. In addition to surroundings sensory system (detector device) 11, vehicle 10 includes vehicle sensor means 19 such as wheel-speed sensors whose results are not only provided to processing means 12 for situation evaluation but also to regulator 14. On the basis of distance d to the nearest object in the travel direction of the vehicle, a setpoint speed v is ascertained with the aid of a characteristic field 20 and conveyed to a speed controller 21. From setpoint speed v, possibly as a function of information from vehicle sensors 19, speed controller 21 ascertains an acceleration value a. In an LOC device 22, a control signal is derived therefrom for driving device 16 and/or braking element 15, which directly accelerate or decelerate vehicle 10. LOC device 22 is used for the longitudinal control of the vehicle in which a coordination or task distribution as a function of acceleration a takes place with respect to driving device 16 and braking element 15.

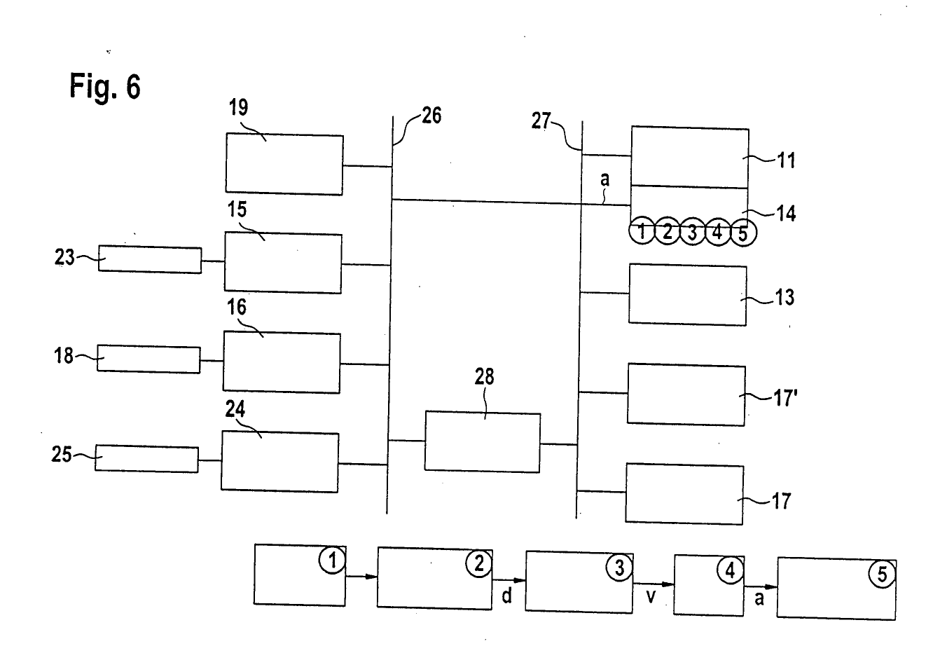

Shown with reference to FIG. 6 is a variant of an architecture of the speed control device for maneuver procedures according to a specific embodiment of the present invention. Vehicle sensors 19 such as an ESP sensory system are coupled to braking element 15 via a drive-train CAN bus 26, braking element 15 being activated via a brake pedal 23. Also coupled to this drive-train CAN bus 26 is driving element 16, activated via driving pedal 18, and a transmission unit 24, controlled via a selector lever 25, transmission unit 24 preferably having an automatic transmission. Drive-train CAN 26 is connected to an interior CAN 27 via a gateway 28. Interior CAN bus 27 connects detection device 11, which includes corresponding sensory means such as ultrasound sensors, to gateway 28. Furthermore, drive-train CAN bus 26 is also coupled directly to output signal a, i.e., an acceleration setpoint selection, of regulator 14. A display device 13, i.e., a loudspeaker and/or a display for distance indication, as well as energizing and de-energizing means 17 and 17′ are preferably also connected to interior CAN bus 27. An energizing means 17 activates/deactivates the speed regulating system, control unit 17′ preferably activating or deactivating a pure parking pilot function, i.e., a pure distance warning indication.

Steps 1 through 5, performed by regulator 14 in FIG. 6 and each characterized by the numbers 1 through 5 in a circle, are also shown at the bottom in FIG. 6. Object detection 1 is followed by a situation evaluation 2 in which distance d to the most proximate obstacle in the travel direction of the vehicle is identified. In step 3 a setpoint value is input, for example with the aid of a characteristics field, in the form of a setpoint speed v, which a regulator converts into an acceleration setpoint selection a in step 4. In step 5, acceleration setpoint selection a is then conveyed directly to driving device 16 or braking element 15 in order to brake or accelerate vehicle 10 correspondingly.

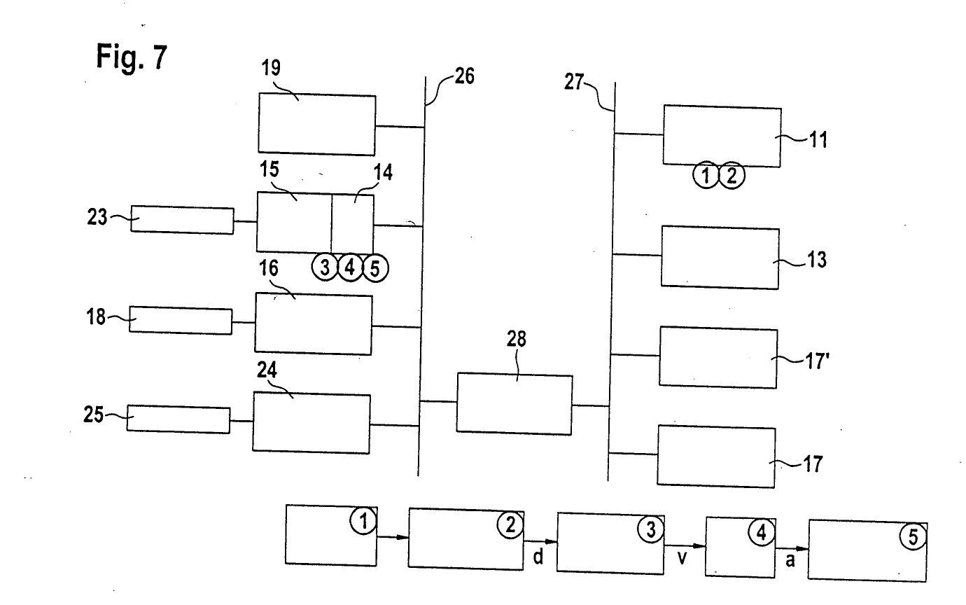

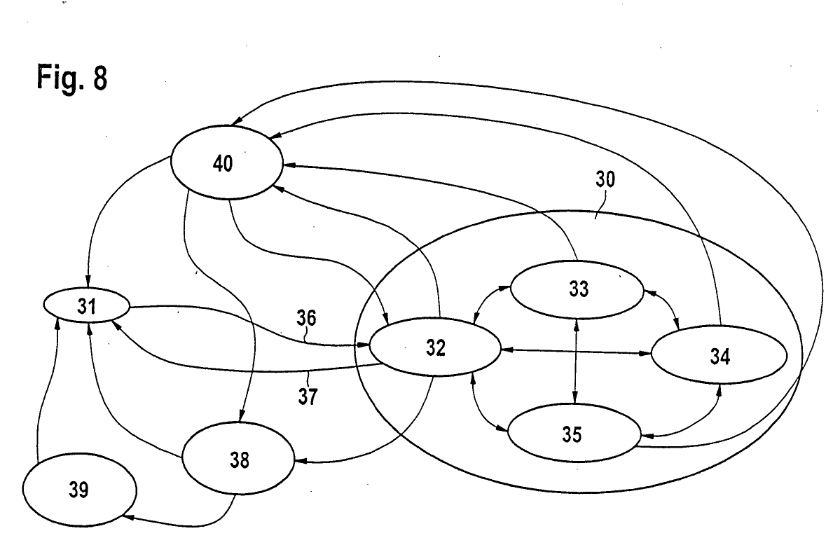

A further variant of the system architecture is shown with reference to FIG. 7. It differs from the variant explained with reference to FIG. 6 in that the actual regulator 14 is located directly in the region of braking element 15 and only one connection exists to interior CAN bus 27 via gateway 28. In this case the afore-discussed steps 1 and 2 are performed within the context of surroundings detection with the aid of detection device 11. Steps 3, 4 and 5 are carried out in another location, namely next to braking element 15 in regulator 14.

With reference to FIG. 8, a schematic state diagram is shown to explain the method of functioning of an example embodiment of the present invention. Reference numeral 30 denotes the active speed control system. The passive system is denoted by reference numeral 31. If system 30 is active, standstill 32, free driving 33, reduced dynamics 34 and comfortable target braking 35 are differentiated as states. If the vehicle is in standstill 32, the speed regulation system may be activated by the driver 36 if it is not active yet, or it may be deactivated 37 if the system is already in activated state 30. If the regulating system is active 30 and the vehicle in standstill 32, a transition to free driving 33 or target braking 35, controlled as a function of speed or distance, may take place.

If the vehicle is in standstill 32 in an activated system 30 and if a predefined time elapses, a standstill-safeguard state 38 is activated. This standstill-safeguard 38 is a temporary state of the automatic initiation of measures to maintain the standstill of the vehicle over a longer period of time. This standstill-safeguard state 38 is preferably also switched on when an automatic parking brake is activated. As soon as the vehicle is safely stopped, i.e., the selector lever has been shifted to position P, for instance, in a vehicle having automatic transmission, the transition to passivated system state 31 takes place automatically. If the initiation of the corresponding measures is unsuccessful, a warning 39 is output. Warning 39 may then be deactivated again by the driver, for instance, in order to attain passive system state 31. Warning 39 is used as acoustic and/or optical indication to the driver to take corresponding safety measures.

If the speed regulation system is active 30, a state of reduced dynamics 34 is switched on when objects or obstacles are poorly detected given limited surroundings detection due to bouncing reflexes or small reflecting cross sections, or else when the steering angle speed is high and a driving path assignment, i.e., a precise travel-direction assignment of the vehicle, is made difficult as a result. Furthermore, this state 34 is able to be activated when the movement direction of the object is unclear, the maneuver speed being reduced as a rule in this state 34. Moreover, in state 34 there is the possibility, for instance, of increasing the brake readiness or of increasing the safety distance to an obstacle located in the travel direction of the vehicle. Should an exceptional situation occur in any of the states when regulating system is activated 30, a fault mode 40 will be activated. In fault mode 40 a safe stopping is ensured if the vehicle is not at a standstill yet, it will be kept at standstill with the aid of the service brake, a fault report preferably taking place. If the exceptional situation has passed, a switch to standstill mode 32 takes place if regulating system 30 is activated. Once the vehicle is stationary, passivated state 31 of the regulating system comes about after deactivation of the regulating system following a preceding fault mode 40. However, if the ignition is turned off in fault mode 40 or if a predefined time elapses, the system enters standstill-safeguard mode 38.

A driver-initiated activation 36 or deactivation of the regulating system is preferably only possible when the brake pedal and the energizing device are depressed simultaneously and the actuation device is not activated, i.e., for instance when the driving pedal is not depressed. The energizing device preferably has a toggle function, and the state, i.e., active or passive, is indicated by. a display. Shifting into drive stage P in a vehicle having automatic transmission also deactivates the system. An exceptional situation as it must exist to activate fault mode 40 is a system malfunction, for instance, or a turned-off ignition or a pulled handbrake or a moving object within the detection range of the detection device or excessive demands on the system. For a reliable standing of the vehicle the transmission must be in position P so as to reliably prevent the vehicle from rolling. Setting the parking brake may perhaps not suffice by itself to ensure a reliable standstill of the vehicle.

Although the present invention is described above on the basis of preferred exemplary embodiments, it is not limited to these, but may be modified in many ways. For instance, the described regulating method or the regulating device is not limited only to the use in passenger cars, but may be utilized in a wide variety of vehicles such as trucks, buses, forklifts or similar vehicles. In addition, the arrangement of the individual components according to FIG. 1 must be considered an example, since in particular processing means 12, regulator 14, display device 13, braking element 15, driving device 16, energizing means 17 and actuating device 18 may occur in other configurations. For example, especially actuating device 18 may not only be designed as driving pedal or accelerator, but also in other form, for example as a slider to be activated by hand, preferably having a restoring force. In addition, the characteristics fields of FIGS. 2 through 4 are also possible as characteristics fields having non-linearly extending characteristics lines so as to provide a gently intervening comfort system for maneuvering/parking, so that the subjective driving feel corresponds to setting the vehicle in motion against growing resistance (rubber-band effect) when approaching an obstacle.

What is claimed is:

1. A method for regulating a speed of a vehicle during maneuvering/parking of the vehicle, comprising:
detecting objects within a surrounding area of the vehicle and recording a distance between a most proximate object to the vehicle in a travel direction and the vehicle, using a detection device;
regulating, using a regulator, a speed of the vehicle while maintaining a first predefined distance to the most proximate object in the travel direction, as a function of a position of an actuating device and of the distance to the most proximate object in the travel direction of the vehicle according to a predefined speed/distance relation; and
controlling a braking element and a driving device of the vehicle as a function of a corresponding output signal of the regulator, using a control device;
wherein, after an activation of the regulator, the regulator utilizes stored characteristics fields to generate an instantaneous setpoint speed as a function of a position of the actuating device and the distance to a most proximate object in the travel direction.
